(19) United States
(12) Patent Application Publication
(10) Pub. No.: US 2019/0288794 A1
(43) Pub. Date: Sep. 19, 2019

(54) BASE STATION APPARATUS, TERMINAL APPARATUS, AND COMMUNICATION METHOD

(71) Applicants: SHARP KABUSHIKI KAISHA, Sakai City, Osaka (JP); FG Innovation Company Limited, Tuen Mun, New Territories (HK)

(72) Inventors: RYOTA YAMADA, Sakai City, Osaka (JP); YASUHIRO HAMAGUCHI, Sakai City, Osaka (JP); KATSUYA KATO, Sakai City, Osaka (JP); HIROMICHI TOMEBA, Sakai City, Osaka (JP)

(21) Appl. No.: 16/464,893

(22) PCT Filed: Dec. 6, 2017
(86) PCT No.: PCT/JP2017/043731

§ 371 Date: May 29, 2019

(30) Foreign Application Priority Data
Dec. 8, 2016 (JP) 2016-238477

(51) Int. Cl. H04L 1/00; H04W 28/04; H04W 74/08; H04B 7/06; H04L 1/18; H04L 5/00; H04W 72/02

(52) U.S. Cl. CPC H04L 1/0047; H04W 28/04; H04W 74/0833; H04B 7/0617; H04W 72/02; H04L 1/0026; H04L 1/1819; H04L 5/0055; H04L 1/0003

(57) ABSTRACT

A coding unit and a radio transmitting unit are included. The coding unit includes a first coding unit, a division unit, and a second coding unit. The first coding unit codes information bits by using first coding. The division unit divides an output from the first coding unit into blocks. The second coding unit performs error correction coding on each of the blocks output by the division unit to generate a coded block. The radio transmitting unit transmits a plurality of the coded blocks at a random transmission timing.

### TECHNICAL FIELD

The present invention relates to a base station apparatus, a terminal apparatus, and a communication method.

This application claims priority based on JP 2016-238477 filed on Dec. 8, 2016, the contents of which are incorporated herein by reference.

### BACKGROUND ART

In a communication system such as Long Term Evolution (LTE) or LTE-Advanced (LTE-A) standardized by the Third Generation Partnership Project (3GPP), the communication area can be widened by forming a cellular configuration in which multiple areas, covered by base station apparatuses (base stations, transmission stations, transmission points, downlink transmission devices, uplink reception devices, a group of transmit antennas, a group of transmit antenna ports, component carriers, eNodeB, Access Point, and AP) or transmission stations equivalent to the base station apparatuses, are deployed in the form of multiple cells (Cells). A terminal apparatus (reception station, reception point, downlink reception apparatus, uplink transmission apparatus, receive antenna group, receive antenna port group, UE, station, and STA) is connected to the base station. In such a cellular configuration, frequency efficiency can be improved by using the same frequency among neighboring cells or sectors.

Research and development activities related to the 5th generation mobile radio communication system (5G system) have been actively carried out, aiming to start commercial services around the year 2020. A vision recommendation on the standard system of the 5G system (International mobile telecommunication-2020 and beyond: IMT-2020) was recently reported (see NPL 1) by the International Telecommunication Union Radio Communications Sector (ITU-R), which is an international standardization body.

The 5G system assumes that a radio access network is operated by combining various frequency bands to satisfy various requirements represented by three large use scenarios (Enhanced mobile broadband (EMBB), Massive machine type communication (mMTC), and Ultra-reliable and low latency communication (URLLC)). In such a context, in order to realize low-delay communication and reduce overhead of control information, a technology of grant-free access (contention-based access), which is an access without scheduling, is under study for 5G.

### CITATION LIST

### Non Patent Literature

NPL 1: “IMT Vision—Framework and overall objectives of the future development of IMT for 2020 and beyond”, Recommendation ITU-R M. 2083-0, September 2015.

### SUMMARY OF INVENTION

### Technical Problem

However, in the grant-free access (contention-based access) technology, a transmit signal (packet) from one terminal apparatus may collide with a transmit signal (packet) from another terminal apparatus. In a case that transmit signals collide with each other, a base station apparatus needs to separate and detect multiple transmit signals in the same time/frequency resource. In a case that a transmit signal cannot be correctly detected, the transmit signal needs to be retransmitted. Accordingly, in a case that the probability that the transmit signals will collide with each other is not low, efficient communication may be prevented.

In view of these circumstances, an object of the present invention is to provide a base station apparatus, a terminal apparatus, and a communication method that enable efficient communication in a case that transmit signals may collide with each other.

### Solution to Problem

To address the above-mentioned drawbacks, a base station apparatus, a terminal apparatus, and a communication method according to an aspect of the present invention are configured as follows.

According to an aspect of the present invention, a terminal apparatus for communicating with a base station apparatus is provided, the terminal apparatus including a coding unit and a radio transmitting unit, wherein the coding unit includes a first coding unit, a division unit, and a second coding unit, the first coding unit codes information bits by using first coding, the division unit divides an output from the first coding unit into blocks, the second coding unit performs error correction coding on each of the blocks output by the division unit to generate a coded block, and the radio transmitting unit transmits a plurality of the coded blocks at a random transmission timing.

In the terminal apparatus according to an aspect of the present invention, the coded block includes a data ID for identifying the information bits.

In the terminal apparatus according to an aspect of the present invention, the number of the coded blocks (the number of blocks resulting from division by the division unit) is indicated by the base station apparatus.

In the terminal apparatus according to an aspect of the present invention, an ACK/NACK signal for the information bits is received from the base station apparatus, and the radio transmitting unit transmits coded blocks the number of which is different from the number of the coded blocks initially transmitted in a case that the ACK/NACK signal indicates NACK.

In the terminal apparatus according to an aspect of the present invention, an ACK/NACK signal for the information bits is received from the base station apparatus, and the radio transmitting unit transmits coded blocks at a transmission interval different from the transmission interval for initial transmission in a case that the ACK/NACK signal indicates NACK.

In the terminal apparatus according to an aspect of the present invention, the radio transmitting unit performs beamforming of a plurality of the coded blocks by using different transmit beams, and transmits the plurality of the coded blocks resulting from the beamforming.

According to an aspect of the present invention, a base station apparatus for communicating with a terminal apparatus is provided, the base station apparatus including a radio receiving unit configured to receive at least one coded block transmitted from the terminal apparatus at a random timing, and a decoding unit configured to decode the at least one coded block, wherein the decoding unit includes a first decoding unit configured to perform error correction decoding on each of the at least one coded block, and a second decoding unit configured to decode an output from the first decoding unit to detect information bits.

In the base station apparatus according to an aspect of the present invention, each of the at least one coded block includes a data ID for identifying the information bits, and the decoding unit detects the information bits from the at least one coded block with an identical data ID.

In the base station apparatus according to an aspect of the present invention, the number of blocks resulting from division by the division unit is indicated to the terminal apparatus.

In the base station apparatus according to an aspect of the present invention, the radio receiving unit receives the at least one coded block on which beamforming is performed by using different transmit beams.

According to an aspect of the present invention, a communication method in a terminal apparatus for communicating with a base station apparatus is provided, the communication method including the steps of coding and performing radio transmission, wherein the step of coding includes first coding, division, and second coding, the step of first coding codes information bits by using first coding, the step of dividing divides an output from the step of first coding into blocks, the step of second coding performs error correction coding on each of the blocks output from the step of dividing to generate a coded block, and the step of performing radio transmission transmits a plurality of the coded blocks at a random transmission timing.

According to an aspect of the present invention, a communication method in a base station apparatus for communicating with a terminal apparatus is provided, the communication method including the steps of receiving at least one coded block transmitted from the terminal apparatus at a random timing, and decoding the at least one coded block, wherein the step of decoding includes first decoding for performing error correction decoding on each of the at least one coded block and second decoding for decoding an output from the first decoding to detect information bits.

### Advantageous Effects of Invention

According to an aspect of the present invention, efficient communication is enabled in a case that transmit signals may collide with each other.

### BRIEF DESCRIPTION OF DRAWINGS

FIG. 1 is a diagram illustrating an example of a communication system according to the present embodiment.

FIG. 2 is a block diagram illustrating an example configuration of a terminal apparatus according to the present embodiment.

FIGS. 3A to 3C are block diagrams illustrating examples of a configuration of a coding unit according to the present embodiment.

FIGS. 4A and 4B are diagrams illustrating examples of transmission timings for coded blocks according to the present embodiment.

FIGS. 5A and 5B are diagrams illustrating examples of transmit beams for coded blocks according to the present embodiment.

FIG. 6 is a diagram illustrating examples of receive beams of a base station apparatus according to the present embodiment.

FIGS. 7A and 7B are diagrams illustrating examples of communication quality of transmit beams and receive beams according to the present embodiment.

FIG. 8 is a block diagram illustrating an example configuration of the base station apparatus according to the present embodiment.

FIGS. 9A to 9C are block diagrams illustrating examples of a configuration of a decoding unit according to the present embodiment.

### DESCRIPTION OF EMBODIMENTS

A communication system according to the present embodiment includes a base station apparatus (a transmitter, cells, a transmission point, a group of transmit antennas, a group of transmit antenna ports, component carriers, and eNodeB) and terminal apparatuses (a terminal, a mobile terminal, a reception point, a reception terminal, a receiver, a group of receive antennas, a group of receive antenna ports, and UE). Furthermore, a base station apparatus connected to a terminal apparatus (base station apparatus that establishes a radio link with a terminal apparatus) is referred to as a serving cell.

The base station apparatus and the terminal apparatus in the present embodiment can communicate in a licensed band and/or an unlicensed band.

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

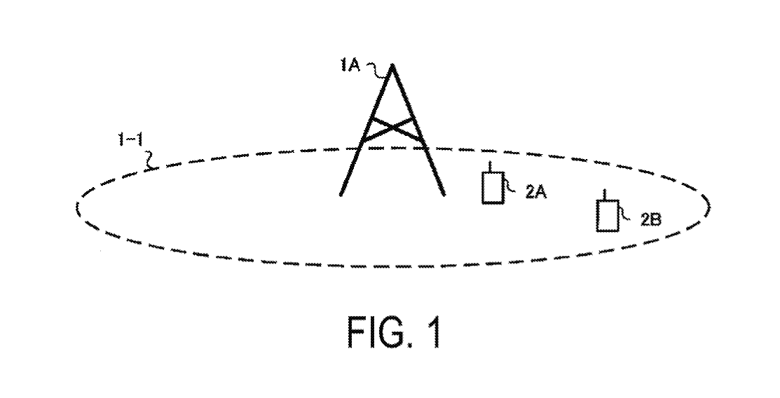

FIG. 1 is a diagram illustrating an example of a communication system according to the present embodiment. As illustrated in FIG. 1, the communication system according to the present embodiment includes a base station apparatus 1A and terminal apparatuses 2A and 2B. Coverage 1-1 is a range (a communication area) in which the base station apparatus 1A can connect to the terminal apparatuses. The terminal apparatuses 2A and 2B are also collectively referred to as terminal apparatuses 2.

With respect to FIG. 1, the following uplink physical channels are used for uplink radio communication from the terminal apparatus 2A to the base station apparatus 1A. The uplink physical channels are used for transmitting information output from a higher layer.

Physical Uplink Control Channel (PUCCH)

Physical Uplink Shared Channel (PUSCH)

Physical Random Access Channel (PRACH)

The PUCCH is used to transmit Uplink Control Information (UCI). The Uplink Control Information includes a positive ACKnowledgement (ACK) or a Negative ACKnowledgement (NACK) (ACK/NACK) for downlink data (a downlink transport block or a Downlink-Shared CHannel (DL-SCH)). ACK/NACK for the downlink data is also referred to as HARQ-ACK or HARQ feedback.

Here, the Uplink Control Information includes Channel State Information (CSI) for the downlink. The Uplink Control Information includes a Scheduling Request (SR) used to request an Uplink-Shared CHannel (UL-SCH) resource. The Channel State Information refers to a Rank Indicator (RI) for specifying a preferred spatial multiplexing number, a Precoding Matrix Indicator (PMI) for specifying a preferred precoder, a Channel Quality Indicator (CQI) for specifying a preferred transmission rate, a CSI-Reference Signal (RS) Resource Indication (CRI) for specifying a preferred CSI-RS resource, and the like.

The Channel Quality Indicator (hereinafter, referred to as a CQI value) can be a preferred modulation scheme (e.g., QPSK, 16QAM, 64QAM, 256QAM, or the like) and a preferred coding rate in a prescribed band (details of which will be described later). The CQI value can be an index (CQI Index) determined by the above change scheme, coding rate, and the like. The CQI value can take a value predetermined in the system.

Note that the Rank Indicator and the Precoding Quality Indicator can take the values predetermined in the system. The Rank Indicator and the Precoding Matrix Indicator can be an index determined by the number of spatial multiplexing and Precoding Matrix information. Note that values of the Rank Indicator, the Precoding Matrix Indicator, and the Channel Quality Indicator are collectively referred to as CSI values.

PUSCH is used for transmission of uplink data (an uplink transport block, UL-SCH). Furthermore, PUSCH may be used for transmission of ACK/NACK and/or Channel State Information along with the uplink data. In addition, PUSCH may be used to transmit the uplink control information only.

PUSCH is used to transmit an RRC message. The RRC message is a signal/information that is processed in a Radio Resource Control (RRC) layer. Further, PUSCH is used to transmit a MAC Control Element (CE). Here, MAC CE is a signal/information that is processed (transmitted) in a Medium Access Control (MAC) layer.

For example, a power headroom may be included in MAC CE and may be reported via PUSCH. In other words, a MAC CE field may be used to indicate a level of the power headroom.

PRACH is used to transmit a random access preamble.

In the uplink radio communication, an UpLink Reference Signal (UL RS) is used as an uplink physical signal. The uplink physical signal is not used for transmission of information output from higher layers, but is used by the physical layer. The Uplink Reference Signal includes a DeModulation Reference Signal (DMRS) and a Sounding Reference Signal (SRS).

DMRS is associated with transmission of PUSCH or PUCCH. For example, the base station apparatus 1A uses DMRS in order to perform channel compensation of PUSCH or PUCCH. SRS is not associated with the transmission of PUSCH or PUCCH. For example, the base station apparatus 1A uses SRS to measure an uplink channel state.

In FIG. 1, the following downlink physical channels are used for the downlink radio communication from the base station apparatus 1A to the terminal apparatus 2A. The downlink physical channels are used for transmitting information output from the higher layer.

Physical Broadcast CHannel (PBCH)

Physical Control Format Indicator CHannel (PCFICH)

Physical Hybrid automatic repeat request Indicator CHannel (PHICH)

Physical Downlink Control CHannel (PDCCH)

Enhanced Physical Downlink Control CHannel (EPDCCH)

Physical Downlink Shared CHannel (PDSCH)

PBCH is used for broadcasting a Master Information Block (MIB, a Broadcast CHannel (BCH)) that is shared by the terminal apparatuses. PCFICH is used for transmission of information for indicating a region (e.g., the number of Orthogonal Frequency Division Multiplexing (OFDM) symbols) to be used for transmission of PDCCH.

PHICH is used for transmission of ACK/NACK with respect to uplink data (a transport block, a codeword) received by the base station apparatus 1A. In other words, PHICH is used for transmission of a HARQ indicator (HARQ feedback) for indicating ACK/NACK with respect to the uplink data. Note that ACK/NACK is also called HARQ-ACK. The terminal apparatus 2A reports received ACK/NACK to a higher layer. ACK/NACK refers to ACK for indicating a successful reception, NACK for indicating an unsuccessful reception, and DTX for indicating that no corresponding data is present. In a case that PHICH for uplink data is not present, the terminal apparatus 2A reports ACK to a higher layer.

The PDCCH and the EPDCCH are used to transmit downlink control information (DCI). Here, multiple DCI formats are defined for transmission of the downlink control information. In other words, a field for the downlink control information is defined in a DCI format and is mapped to information bits.

For example, as a DCI format for the downlink, DCI format 1A to be used for the scheduling of one PDSCH in one cell (transmission of a single downlink transport block) is defined.

For example, the DCI format for the downlink includes downlink control information such as information of PDSCH resource allocation, information of a Modulation and Coding Scheme (MCS) for PDSCH, and a TPC command for PUCCH. Here, the DCI format for the downlink is also referred to as downlink grant (or downlink assignment).

Furthermore, for example, as a DCI format for the uplink, DCI format 0 to be used for the scheduling of one PUSCH in one cell (transmission of a single uplink transport block) is defined.

For example, the DCI format for the uplink includes uplink control information such as information of PUSCH resource allocation, information of MCS for PUSCH, and a TPC command for PUSCH. Here, the DCI format for the uplink is also referred to as uplink grant (or uplink assignment).

Furthermore, the DCI format for the uplink can be used to request Channel State Information (CSI; also referred to as reception quality information) for the downlink (CSI request).

The DCI format for the uplink can be used for a configuration for indicating an uplink resource to which a CSI feedback report is mapped, the CSI feedback report being fed back to the base station apparatus by the terminal apparatus. For example, the CSI feedback report can be used for a configuration for indicating an uplink resource that periodically reports Channel State Information (periodic CSI). The CSI feedback report can be used for a mode configuration (CSI report mode) for periodically reporting the Channel State Information.

For example, the CSI feedback report can be used for a configuration for indicating an uplink resource that reports aperiodic Channel State Information (aperiodic CSI). The CSI feedback report can be used for a mode configuration (CSI report mode) for aperiodically reporting the Channel State Information. The base station apparatus can configure any one of the periodic CSI feedback report and the aperiodic CSI feedback report. In addition, the base station apparatus can configure both the periodic CSI feedback report and the aperiodic CSI feedback report.

The DCI format for the uplink can be used for a configuration for indicating a type of the CSI feedback report that is fed back to the base station apparatus by the terminal apparatus. The type of the CSI feedback report includes wideband CSI (e.g., Wideband CQI), narrowband CSI (e.g., Subband CQI), and the like.

In a case where a PDSCH resource is scheduled in accordance with the downlink assignment, the terminal apparatus receives downlink data on the scheduled PDSCH. In a case where a PUSCH resource is scheduled in accordance with the uplink grant, the terminal apparatus transmits uplink data and/or uplink control information on the scheduled PUSCH.

PDSCH is used to transmit downlink data (a downlink transport block, DL-SCH). PDSCH is used to transmit a system information block type 1 message. The system information block type 1 message is cell-specific information.

The PDSCH is used to transmit a system information message. The system information message includes a system information block X other than the system information block type 1. The system information message is cell-specific information.

PDSCH is used to transmit an RRC message. Here, the RRC message transmitted from the base station apparatus may be shared by multiple terminal apparatuses in a cell. Further, the RRC message transmitted from the base station apparatus 1A may be a dedicated message to a given terminal apparatus 2 (also referred to as dedicated signaling). In other words, user equipment specific information (unique to user equipment) is transmitted by using a message dedicated to the given terminal apparatus. PDSCH is used to transmit MAC CE.

Here, the RRC message and/or MAC CE is also referred to as higher layer signaling.

PDSCH can be used to request downlink channel state information. PDSCH can be used for transmission of an uplink resource to which a CSI feedback report is mapped, the CSI feedback report being fed back to the base station apparatus by the terminal apparatus. For example, the CSI feedback report can be used for a configuration for indicating an uplink resource that periodically reports channel state information (periodic CSI). The CSI feedback report can be used for a mode configuration (CSI report mode) for periodically reporting the Channel State Information.

The type of the downlink Channel State Information report includes wideband CSI (e.g., Wideband CSI) and narrowband CSI (e.g., Subband CSI). The wideband CSI calculates one piece of Channel State Information for the system band of a cell. The narrowband CSI divides the system band in predetermined units, and calculates one piece of Channel State Information for each division.

In the downlink radio communication, a Synchronization signal (SS) and a DownLink Reference Signal (DL RS) are used as downlink physical signals. The downlink physical signals are not used for transmission of information output from the higher layers, but are used by the physical layer.

The synchronization signal is used for the terminal apparatus to take synchronization in the frequency domain and the time domain in the downlink. The Downlink Reference Signal is used for the terminal apparatus to perform channel compensation on a downlink physical channel. For example, the Downlink Reference Signal is used for the terminal apparatus to calculate the downlink Channel State Information.

Here, the Downlink Reference Signals include a Cell-specific Reference Signal (CRS), a UE-specific Reference Signal (URS) relating to PDSCH, a DeModulation Reference Signal (DMRS) relating to EPDCCH, a Non-Zero Power Chanel State Information-Reference Signal (NZP CSI-RS), and a Zero Power Chanel State Information-Reference Signal (ZP CSI-RS).

CRS is transmitted in an entire band of a subframe and is used to perform demodulation of PBCH/PDCCH/PHICH/PCFICH/PDSCH. URS relating to PDSCH is transmitted in a subframe and a band that are used for transmission of PDSCH to which URS relates, and is used to demodulate PDSCH to which URS relates.

DMRS relating to EPDCCH is transmitted in a subframe and a band that are used for transmission of EPDCCH to which DMRS relates. DMRS is used to demodulate EPDCCH to which DMRS relates.

A resource for NZP CSI-RS is configured by the base station apparatus 1A. The terminal apparatus 2A performs signal measurement (channel measurement) by using NZP CSI-RS. A resource for ZP CSI-RS is configured by the base station apparatus 1A. With zero output, the base station apparatus 1A transmits ZP CSI-RS. The terminal apparatus 2A performs interference measurement in a resource to which NZP CSI-RS corresponds, for example.

A Multimedia Broadcast multicast service Single Frequency Network (MBSFN) RS is transmitted in an entire band of the subframe used for transmitting PMCH. MBSFN RS is used to demodulate PMCH. PMCH is transmitted through the antenna port used for transmission of MBSFN RS.

Here, the downlink physical channel and the downlink physical signal are also collectively referred to as a downlink signal. The uplink physical channel and the uplink physical signal are also collectively referred to as an uplink signal. The downlink physical channel and the uplink physical channel are collectively referred to as a physical channel. The downlink physical signal and the uplink physical signal are also collectively referred to as a physical signal.

BCH, UL-SCH, and DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing or the like is performed for each codeword.

Furthermore, for terminal apparatuses that support Carrier Aggregation (CA), the base station apparatus can integrate multiple Component Carriers (CCs) for transmission in a broader band to perform communication. In carrier aggregation, one Primary Cell (PCell) and one or more Secondary Cells (SCells) are configured as a set of serving cells.

Furthermore, in Dual Connectivity (DC), a Master Cell Group (MCG) and a Secondary Cell Group (SCG) are configured as a group of serving cells. MCG includes a PCell and optionally one or more SCells. Furthermore, SCG includes a primary SCell (PSCell) and optionally one or more SCells.

The base station apparatus can communicate by using a radio frame. The radio frame includes multiple subframes (sub-periods). In a case that a frame length is expressed in time, for example, a radio frame length can be 10 milliseconds (ms), and a subframe length can be 1 ms. In this example, the radio frame includes 10 subframes. Furthermore, the subframe includes multiple OFDM symbols, thus the subframe length can be expressed in the number of OFDM symbols. For example, the subframe can be expressed in the number of OFDM symbols at a reference subcarrier spacing (for example, 15 kHz). For example, the number of OFDM symbols for indicating the subframe length can be 14. Furthermore, the subframe includes multiple slots. The slot is expressed in the number of OFDM symbols at a subcarrier spacing used for transmission. The number of OFDM symbols of the slot may be associated with the number of OFDM symbols of the subframe. For example, the number of OFDM symbols of the slot can be the same as or half of the number of OFDM symbols of the subframe. For example, the slot includes 7 or 14 OFDM symbols. Furthermore, the number of OFDM symbols constituting the slot may vary according to the subcarrier spacing. For example, in a case of a subcarrier spacing of 60 kHz or higher, the slot includes 14 OFDM symbols. In the description below, the subframe length, in a case of being expressed in time, is 1 ms. However, the aspect of the present invention is not limited to this. Furthermore, the subframe/slot can include an uplink period during which an uplink signal/channel is communicated and a downlink period during which a downlink signal/channel is communicated. In other words, the subframe/slot may include only an uplink period, only a downlink period, or an uplink period and a downlink period. Furthermore, the subframe/slot can include a guard period (null period). Note that a position at which the guard period can be allocated and/or a guard period length may be fixed or configured by the base station apparatus. Furthermore, a configurable period length may vary depending on whether the guard period is allocated before or after the subframe/slot. Furthermore, the period lengths may be fixed for a subframe/slot including an uplink period, a downlink period, and a guard period, depending on the allocation of the periods. Furthermore, the base station apparatus can configure, in a higher layer, the allocation and the period lengths of the uplink period/downlink period/guard period in the subframe/slot, and transmit, to the terminal, the allocation and the period lengths included in control information. Furthermore, the base station apparatus can be configured for each subframe/slot or each subframe group. Furthermore, a minislot shorter than the slot may be defined. The subframe/slot/minislot can be used as a scheduling unit. For example, in a case that the slot is 14 OFDM symbols, the minislot may be 2, 4, or 7 OFDM symbols. Furthermore, for example, in a case that the slot is 7 OFDM symbols, the minislot is 4 or 7 OFDM symbols.

The subframe/slot includes one or more OFDM symbols. In the embodiments below, it is assumed that the OFDM symbol refers to a symbol generated based on Inverse Fast Fourier Transform (IFFT), and that the OFDM signal refers to an OFDM symbol to which a guard period is added. Note that the guard period is a zero period (null period) or Cyclic Prefix (CP). Note that the guard period length may be zero.

Multiple parameters may be configured to generate OFDM symbols. The parameters include a subcarrier spacing and/or the number of Fast Fourier Transform (FFT) points. Furthermore, a base parameter is configured that is a basis for multiple parameters. Note that the base parameter is also referred to as a reference parameter. The parameters other than the base parameter can be determined based on the base parameter. For example, in a case that the base parameter is a subcarrier spacing of 15 kHz, the parameters other than the base parameter can each be N-times the subcarrier spacing of 15 kHz. Note that N is an integer or the m-th power of 2 or a fraction. Note that m is an integer and includes a negative number such as m=−2. Note that the N or m is referred to as a scale factor for the subcarrier spacing (parameter set). Furthermore, a parameter, such as a subcarrier spacing, that has a fixed value is referred to as a parameter set. In the embodiments described below, by way of example, a first parameter set is a subcarrier spacing of 15 kHz and a second parameter set is a subcarrier spacing of 30 kHz, unless otherwise noted. However, the aspect of the present invention is not limited to this. Furthermore, the number of parameter sets that can be configured by the base station apparatus is not limited to two. In the embodiments described below, the number of FFT points is the same between the first parameter set and the second parameter set, unless otherwise noted. In other words, the OFDM symbol length decreases as the subcarrier spacing increases. Furthermore, OFDM symbols generated by the first parameter set and the second parameter set are respectively referred to as first OFDM symbols and second OFDM symbols.

Furthermore, for a reduction in the adverse effect of phase noise or the like, the subcarrier spacing is desirably increased as the carrier frequency (band) becomes higher. Accordingly, the base station apparatus can configure a base parameter set by using a carrier frequency (band) or a carrier frequency range (band range). For example, a first frequency range (band range) covers carrier frequencies lower than 6 GHz, a second frequency range (band range) covers carrier frequencies higher than or equal to 6 GHz and lower than 40 GHz, and a third frequency range (band range) covers carrier frequencies higher than or equal to 40 GHz. In this case, the base station apparatus can configure the base parameter to be a subcarrier spacing of 15 kHz within the first carrier frequency range. The base station apparatus can also configure the base parameter to be a subcarrier spacing of 60 kHz within the second carrier frequency range. The base station apparatus can also configure the base parameter to be a subcarrier spacing of 240 kHz within the third carrier frequency range.

Furthermore, multiple types of CP lengths may be configured. Multiple types of CP lengths may also be configured for each parameter set. For example, two types of CP lengths are configured. Furthermore, the two types of CPs are respectively referred to as a first CP and a second CP. For the same parameter set, the second CP length is longer than the first CP length. Furthermore, the radio (overhead) of the first CP length and the second CP length to OFDM symbols can be almost the same for each parameter set. Note that the first CP is also referred to as a normal CP and that the second CP is also referred to as an extended CP. Furthermore, an OFDM signal in which the first CP is added to the first OFDM symbol is referred to as a first OFDM signal-1, and an OFDM signal in which the second CP is added to the first OFDM symbol is referred to as a first OFDM signal-2. Furthermore, an OFDM signal in which the first CP is added to the second OFDM symbol is referred to as a second OFDM signal-1, and an OFDM signal in which the second CP is added to the second OFDM symbol is referred to as a second OFDM signal-2. Note that multiple CP lengths may not be configured in some parameter sets. Furthermore, the number of CP lengths configured may vary for each parameter set. Note that multiple CP lengths may be configured in a special parameter set. Note that, in the embodiments described above or below, OFDM symbols/signals are used even for description of the uplink (corresponding to a case where the terminal apparatus performs transmission) but that the OFDM symbols/signals include the meanings of OFDM symbols/signals and SC-FDMA symbols/signals unless otherwise noted. Furthermore, the parameter set and the CP length can each have the same configuration or different configurations for the downlink and the uplink. The terminal apparatus can demodulate downlink signals (OFDM signals) by using the parameter set and the CP length configured for the downlink and transmit uplink signals (OFDM signals and SC-FDMA signals) by using the parameter set and the CP length configured for the uplink. Note that the reference parameter may be common to the uplink and the downlink. In this case, the subframe lengths determined from the reference parameter are equal between the uplink and the downlink.

Note that the number of subframes/slots included in a prescribed time period can have the same value or different values between the uplink and the downlink. For example, the number of subframes/slots included in the prescribed time period in the downlink can be smaller than the number of subframes/slots included in the prescribed time period in the uplink and vice versa. The base station apparatus and the terminal apparatus included in the above-described communication system can provide a communication service with different requirements configured for the uplink and the downlink. The communication service is, for example, a communication service in which high-speed transmission such as video transmission is performed in the downlink, and low delay response to the video transmission is required in the uplink. In other words, a case where the subframe/slot length in the uplink needs to be configured to be smaller than the subframe/slot length in the downlink is included. Again, the present embodiment includes a case where the subframe/slot length in the downlink needs to be configured to be smaller than the subframe/slot length in the uplink.

Note that, in a case that part of the resources in the uplink or the downlink are used for transmission in another link (for example, a sidelink), the terminal apparatus can use, for the transmission in the sidelink, a parameter set and a CP length that are different from the parameter set and the CP length configured for the uplink transmission (or downlink transmission) using the part of the resources, or the parameter set and the CP length can be configured by the base station apparatus. Of course, the terminal apparatus can use, for the transmission in the sidelink, the same parameter set and CP length as those configured for the uplink transmission (or downlink transmission) using the part of the resources. Furthermore, a dedicated parameter set and a CP length for the sidelink can be configured in the terminal apparatus.

In the present embodiment, sizes in the time domain such as the frame length, symbol length, and CP length are expressed in basic time units Ts. Note that points represent the number of certain basic time units Ts unless otherwise noted. For example, in a case that CP is expressed in NCP points, the CP length is the product of NCP and Ts. Here, the basic time unit Ts can be determined from a subcarrier spacing and an FFT size (the number of FFT points). Here, in a case that the subcarrier spacing is represented as SCS and the number of FFT points is represented as NFFT, Ts=1/(SCS×NFFT) seconds (here, / means a division). Accordingly, in a case that the subcarrier spacing is multiplied by N with the number of FFT points remaining the same, the CP length is divided by N. Note that Ts may be, for example, a time unit based on reference parameters (subcarrier spacing and the number of FFT points) such as SCS=15 kHz and NFFT=2048 points. In this case, the basic time unit is Ts/N (here, / means a division) in a case that the subcarrier spacing is 15N kHz. Furthermore, in a case that NFFT is multiplied by N with SCS remaining the same, the basic time unit is Ts/N (here, / means a division).

Furthermore, with a common NFFT, the number of CP points can be common to all parameters except for some OFDM symbols. For example, the first CP can have 144 points and the second CP can have 512 points for the OFDM symbols other than the first symbol of 0.5 ms. Furthermore, with the same NFFT, the system bandwidth varies according to SCS. Note that such a system bandwidth determined by SCS is also referred to as a reference system bandwidth. For example, the reference system bandwidth can be 20 MHz in a case of SCS=15 kHz and 80 MHz in a case of SCS=60 kHz. In a case that the system bandwidth is the same for each SCS, NFFT is different for each SCS, Ts is kept the same by SCS, and the number of CP points varies according to SCS. Note that not all the parameter sets may follow a unified rule based on a variation in SCS, for example, multiplication by N. In other words, the overheads of the first CP/second CP may not be equal for all the parameter sets. For example, in a case that N is a fraction, the overhead of CP can be reduced. Furthermore, in a case that N is 4 or larger or the like, leading a large reference system bandwidth, the overhead of CP can be reduced. Note that a CP of which overhead is less than the first CP is referred to as a Shortened CP (SCP). Furthermore, the shortened CP is also referred to as a third CP. Note that the third CP may include a case of NCP=0. Note that a third CP having a zero length is also referred to as a zero CP. Furthermore, a signal in which the third CP is added to OFDM symbols is referred to as an OFDM signal-3. Note that the OFDM signal-3 may not be time-multiplexed with the OFDM signal-1 and the OFDM signal-2. Furthermore, the OFDM signal-3 may not be time-multiplexed/frequency-multiplexed with the OFDM signal-1 and the OFDM signal-2. Furthermore, in a case of adding the third CP, the base station apparatus can configure a CP length specific to the terminal apparatus (guard period length, zero period length, or null period length). In this case, the base station apparatus can transmit the third CP on a control channel commonly used within the cell and transmit the CP length specific to the terminal on a control channel specific to the terminal. Furthermore, the third CP may be configured only within a certain carrier frequency range.

In general, delay spread is similar at equivalent carrier frequencies regardless of the subcarrier spacing, thus the CP length desirably has a value at which the delay spread causes a less adverse effect. Accordingly, the base station apparatus can configure a base (reference) CP length for each parameter set at the carrier frequency or within the carrier frequency range. For example, within the first carrier frequency range, the first CP can be the base CP for the first parameter set and the second CP can be the base CP for the second parameter set. Note that the delay spread is affected by coverage (transmit power) of the base station apparatus, a cell radius, a distance between the base station apparatus and the terminal apparatus, and the like, thus, at the same carrier frequency, varying the CP length for each base station apparatus/each terminal apparatus enables efficient communication. Accordingly, in the same subframe, the base station apparatus/terminal apparatus can multiplex, in the time domain/frequency domain, the OFDM symbols to which the first CP is added and the OFDM symbols to which the second CP is added. The base station apparatus/terminal apparatus can then transmit the resultant OFDM symbols. The OFDM symbols to which the first CP is added and the OFDM symbols to which the second CP is added may be the same parameter set or different parameter sets. Furthermore, in a case that the subframe is configured to be the number of OFDM symbols corresponding to the reference parameter (subcarrier spacing), the number of OFDM symbols may be determined with the first CP or the second CP taken into account. Furthermore, the first CP or the second CP, or the CP length may be included in the reference parameters.

Note that the parameter set supported by the terminal apparatus is reported to the base station apparatus as a function (capability) or a category of the terminal apparatus. Furthermore, information for indicating whether the first CP/second CP/third CP is supported at a certain subcarrier spacing can be included in the function (capability) or the category of the terminal apparatus. The information for indicating whether the first CP/second CP/third CP is supported can be indicated for each band or for each band combination. The base station apparatus can transmit a transmit signal with the parameter set or the CP length supported by the terminal apparatus, based on the function (capability) or the category of the terminal apparatus received from the terminal apparatus.

The base station apparatus/terminal apparatus transmits, to the terminal apparatus/base station apparatus, a demodulation reference signal (UE specific reference signal, Demodulation Reference Signal (DMRS), a downlink demodulation reference signal, and an uplink demodulation reference signal) used for data demodulation. The base station apparatus/terminal apparatus uses the demodulation reference signal to demodulate a data signal. 5G is required to support various use cases and bandwidths. Examples of the requirement include a low transmission rate, a high transmission rate, low delay, high reliability, a high-speed moving environment, and a high-frequency band communication. Demodulations are desirably enabled that are respectively suitable for such various radio environments and transmission schemes. Thus, desirably, the demodulation reference signals can be flexibly transmitted (configured). Furthermore, in a case that a common signal waveform, such as an OFDM, is used in the downlink and the uplink, the reference signals of the downlink and the uplink desirably have a common configuration (setting) to some extent.

The terminal apparatus can perform data transmission (access) without scheduling (transmission of uplink grant) particularly to achieve required low-delay communication and to reduce the power consumption of a low-cost terminal. Note that the data transmission without scheduling (uplink grant) is also referred to as grant-free access. Furthermore, the lack of scheduling may cause a collision of data between terminal apparatuses, thus the data transmission without scheduling is also referred to as contention-based access. In the grant-free access, the base station apparatus does not perform scheduling, and need not transmit scheduling information to the terminal apparatus. Furthermore, the terminal apparatus need not receive the scheduling information, and need not monitor the uplink grant.

In the grant-free access, each terminal apparatus can share radio resources to transmit data. For example, the radio resource includes a multiple access physical resource and a multiple access signature. For example, the multiple access physical resource is represented by time or frequency. Furthermore, the multiple access signature indicates some or all of a spreading code, a codebook, a sequence, an interleaver, a resource mapping pattern, a demodulation reference signal, a preamble, a space resource (beam pattern and beam direction), and transmit power. Note that multiple access physical resources are orthogonal to one another, and are also referred to as orthogonal resource. Furthermore, in the multiple access signature, interference may occur even in a case that the resources are separated, thus the multiple access signature is also referred to as non-orthogonal resource. The terminal apparatus can select a multiple access physical resource and a multiple access signature for data transmission. Furthermore, the multiple access physical resource/multiple access signature may be configured commonly for a data signal and a reference signal (configured to link the data signal to the reference signal). Furthermore, the multiple access physical resource/multiple access signature may be configured independently between the data signal and the reference signal. In this case, the multiple access physical resource for the reference signal is also referred to as a reference signal physical resource. Furthermore, the multiple access signature for the reference signal is also referred to as a reference signal signature. For example, the reference signal physical resource indicates a time/frequency resource and/or time density and frequency density. Furthermore, for example, the reference signal signature includes some or all of an orthogonal cover code, a transmit beam, and a cyclic shift. The time density indicates that the reference signal is mapped at intervals of N (N is an integer and N>0) symbols/slots/subframes. The time density can indicate one of N mapping patterns. For example, for N=2, the time density indicates an even number of symbols/slots/subframes or an odd number of symbols/slots/subframes. The frequency density indicates that the reference signal is mapped at intervals of M (M is an integer and M>0) subcarriers/subbands. The frequency density can indicate one of M mapping patterns. For example, for M=2, the frequency density indicates an even number of subcarriers/subbands or an odd number of subcarriers/subbands. Furthermore, the reference signal physical reference and the reference signal signature may be linked to each other by an antenna port number. For example, the antenna port number can indicate one of the reference signal physical resources and one of the reference signal signatures.

The base station apparatus can indicate or configure, to the terminal apparatus, a radio resource that enables grant-free access. For example, the base station apparatus can configure grant-free resource pool by higher layer signalling. In this case the terminal apparatus can randomly select a resource from the resource pool and transmit a data signal and/or a reference signal at any transmission timing. Note that the resource pool can indicate a time resource and/or a frequency resource and/or a space resource. Furthermore, whether the resource pool is available or not can be controlled by using information such as active/deactive.

Furthermore, the base station apparatus can transmit downlink control information common to multiple terminal apparatuses, the downlink control information including information of available resources. The information of available resources indicates some or all of a multiple access physical resource available, a multiple access signature available, a reference signal physical resource available, and a reference signal signature available. The terminal apparatus can transmit the data signal and/or the reference signal by using a resource indicated in the information of available references included in the common downlink control information.

Furthermore, the terminal apparatus observes a surrounding communication situation (performs carrier sense), and in a case of determining that no apparatus is in communication (idle), the terminal apparatus can transmit a signal. A period of carrier sense is fixed or random.

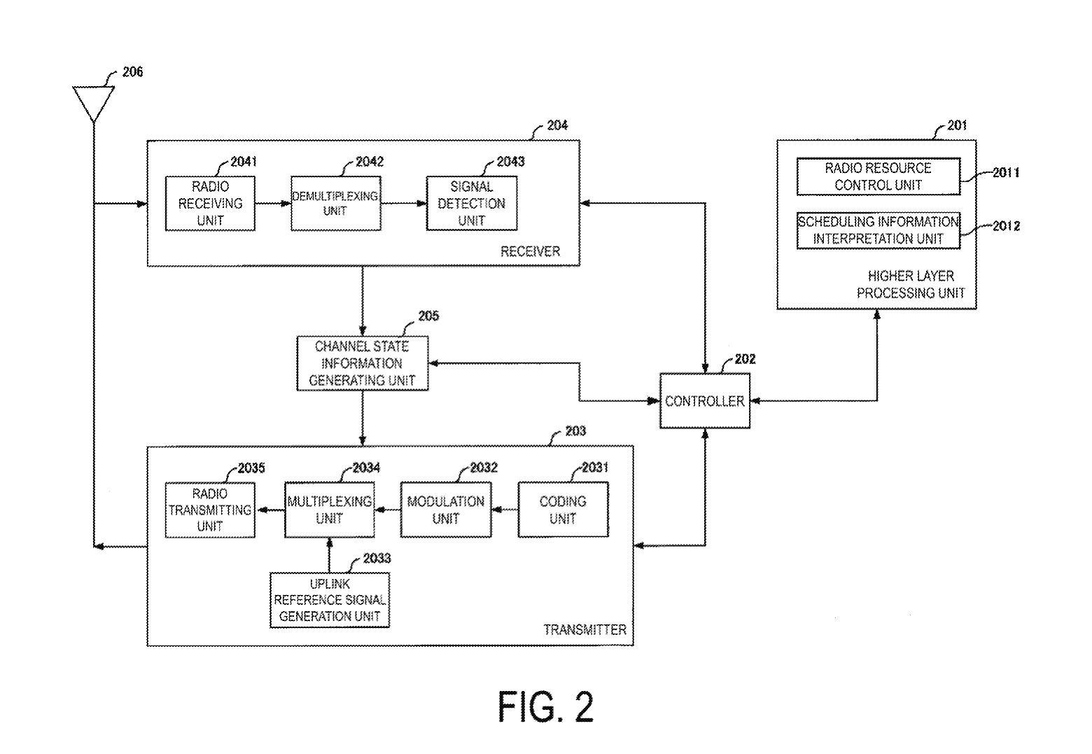

FIG. 2 is a schematic block diagram illustrating a configuration of the terminal apparatus 2 according to the present embodiment. As illustrated in FIG. 12, the terminal apparatus 2A is configured to include a higher layer processing unit (higher layer processing step) 201, a controller (controlling step) 202, a transmitter (transmitting step) 203, a receiver (receiving step) 204, a channel state information generation unit (channel state information generating step) 205, and a transmit and/or receive antenna 206. The higher layer processing unit 201 is configured to include a radio resource control unit (radio resource controlling stop) 2011 and a scheduling information interpretation unit (scheduling information interpreting step) 2012. The transmitter 203 is configured to include a coding unit (coding step) 2031, a modulation unit (modulating step) 2032, an uplink reference signal generation unit (uplink reference signal generating step) 2033, a multiplexing unit (multiplexing step) 2034, and a radio transmitting unit (radio transmitting step) 2035. The receiver 204 is configured to include a radio receiving unit (radio receiving step) 2041, a demultiplexing unit (demultiplexing step) 2042, and a signal detection unit (signal detecting step) 2043.

The higher layer processing unit 201 outputs, to the transmitter 203, the uplink data (the transport block) generated by a user operation or the like. The higher layer processing unit 201 performs processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs information of a terminal apparatus, such as UE capability or the like, to the transmitter 203.

Note that in the following description, information of a terminal apparatus includes information for indicating whether the terminal apparatus supports a prescribed function, or information for indicating that the terminal apparatus has completed the introduction and test of a prescribed function. In the following description, information of whether the prescribed function is supported includes information of whether the introduction and test of the prescribed function have been completed.

For example, in a case where a terminal apparatus supports a prescribed function, the terminal apparatus transmits information (parameters) for indicating whether the prescribed function is supported. In a case where a terminal apparatus does not support a prescribed function, the terminal apparatus does not transmit information (parameters) for indicating whether the prescribed function is supported. In other words, whether the prescribed function is supported is reported by whether information (parameters) for indicating whether the prescribed function is supported is transmitted. Information (parameters) for indicating whether a prescribed function is supported may be reported by using one bit of 1 or 0.

Furthermore, the radio resource control unit 2011 manages various configuration information of the terminal apparatuses 2A. Furthermore, the radio resource control unit 2011 generates information to be mapped to each uplink channel, and outputs the generated information to the transmitter 203.

The radio resource control unit 2011 acquires configuration information of CSI feedback transmitted from the base station apparatus, and outputs the acquired information to the controller 202. Furthermore, the radio resource control unit 1011 acquires configuration information such as a downlink reference parameter (subcarrier spacing), a CP length, and the number of FFT points from the base station apparatus, and outputs the configuration information to the controller 202. Furthermore, the radio resource control unit 1011 acquires configuration information such as an uplink reference parameter (subcarrier spacing), a CP length, and the number of FFT points from the base station apparatus, and outputs the configuration information to the controller 202.

The scheduling information interpretation unit 2012 interprets the downlink control information received through the receiver 204, and determines scheduling information. The scheduling information interpretation unit 2012 generates control information in order to control the receiver 204 and the transmitter 203 in accordance with the scheduling information, and outputs the generated information to the controller 202.

Based on the information input from the higher layer processing unit 201, the controller 202 generates a control signal for controlling the receiver 204, the channel state information generation unit 205, and the transmitter 203. The controller 202 outputs the generated control signal to the receiver 204, the channel state information generation unit 205, and the transmitter 203 to control the receiver 204 and the transmitter 203.

The controller 202 controls the transmitter 203 to transmit CSI generated by the channel state information generation unit 205 to the base station apparatus.

In accordance with the control signal input from the controller 202, the receiver 204 demultiplexes, demodulates, and decodes a reception signal received from the base station apparatus 1A through the transmit and/or receive antenna 206, and outputs the resulting information to the higher layer processing unit 201.

The radio receiving unit 2041 converts, by down-converting, a downlink signal received through the transmit and/or receive antenna 206 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 2041 removes a portion corresponding to CP from the digital signal resulting from the conversion, performs fast Fourier transform of the signal from which the CP has been removed, and extracts a signal in the frequency domain.

The demultiplexing unit 2042 demultiplexes the extracted signal into PHICH, PDCCH, EPDCCH, PDSCH, and the downlink reference signal. Furthermore, the demultiplexing unit 2042 performs channel compensation for PHICH, PDCCH, and EPDCCH based on a channel estimation value of a desired signal obtained from channel measurement, detects downlink control information, and outputs the detected downlink control information to the controller 202. The controller 202 outputs PDSCH and the channel estimation value of the desired signal to the signal detection unit 2043.

The signal detection unit 2043, by using PDSCH and the channel estimation value, detects a signal, and outputs the detected signal to the higher layer processing unit 201.

The transmitter 203 generates an uplink reference signal in accordance with the control signal input from the controller 202, codes and modulates the uplink data (the transport block) input from the higher layer processing unit 201, multiplexes PUCCH, PUSCH, and the generated uplink reference signal, and transmits a signal resulting from the multiplexing to the base station apparatus 1A through the transmit and/or receive antenna 206.

The coding unit 2031 codes the uplink control information input from the higher layer processing unit 201 in compliance with a coding scheme, such as convolutional coding, block coding, or polar codes. Furthermore, the coding unit 2031 performs error correction coding such as turbo coding, Low Density Parity Check (LDPC) coding, polar coding, or block coding, and/or rateless coding such as Luby Transform (LT) coding or Raptor coding, based on information used for scheduling of PUSCH. An LT code randomly selects d (d=1, 2, . . . ) bits from input bits and performs exclusive-OR operation on the d bits to generate coded bits. A selectable number of coded bits are generated. A value of d complies with a degree distribution, for example, an ideal soliton distribution or a robust soliton distribution. Note that a pattern of d (candidate sequence) may be specified. Raptor codes are codes in which LDPC codes and LT codes are combined.

The modulation unit 2032 modulates the coded bits input from the coding unit 2031, in compliance with a modulation scheme, such as BPSK, QPSK, 16QAM, or 64QAM, that is notified by using the downlink control information, or in compliance with a modulation scheme predetermined for each channel.

The uplink reference signal generation unit 2033 generates a sequence that is determined according to a predetermined rule (formula), based on a Physical Cell Identity (PCI, also referred to as a cell ID or the like) for identifying the base station apparatus 1A, a bandwidth in which the uplink reference signal is mapped, a cyclic shift notified by using the uplink grant, a parameter value for generation of a DMRS sequence, and the like.

In accordance with the control signal input from the controller 202, the multiplexing unit 2034 rearranges modulation symbols of PUSCH in parallel and then performs Discrete Fourier Transform (DFT) of the rearranged modulation symbols. Furthermore, the multiplexing unit 2034 multiplexes PUCCH and PUSCH signals and the generated uplink reference signal for each transmit antenna port. To be more specific, the multiplexing unit 2034 maps the PUCCH and PUSCH signals and the generated uplink reference signal to resource elements for each transmit antenna port.

The radio transmitting unit 2035 performs Inverse Fast Fourier Transform (IFFT) on a signal resulting from the multiplexing to perform the modulation of SC-FDMA scheme to generate an SC-FDMA symbol, adds CP to the generated SC-FDMA symbol to generate a baseband digital signal (SD-FDMA signal), converts the baseband digital signal into an analog signal, removes unnecessary frequency components, up-converts the resulting analog signal into a signal of a carrier frequency, performs power amplification, and outputs the resulting signal to the transmit and/or receive antenna 206 for transmission.

Note that the terminal apparatus 2 can perform modulation according to not only the SC-FDMA scheme but also the OFDMA scheme.

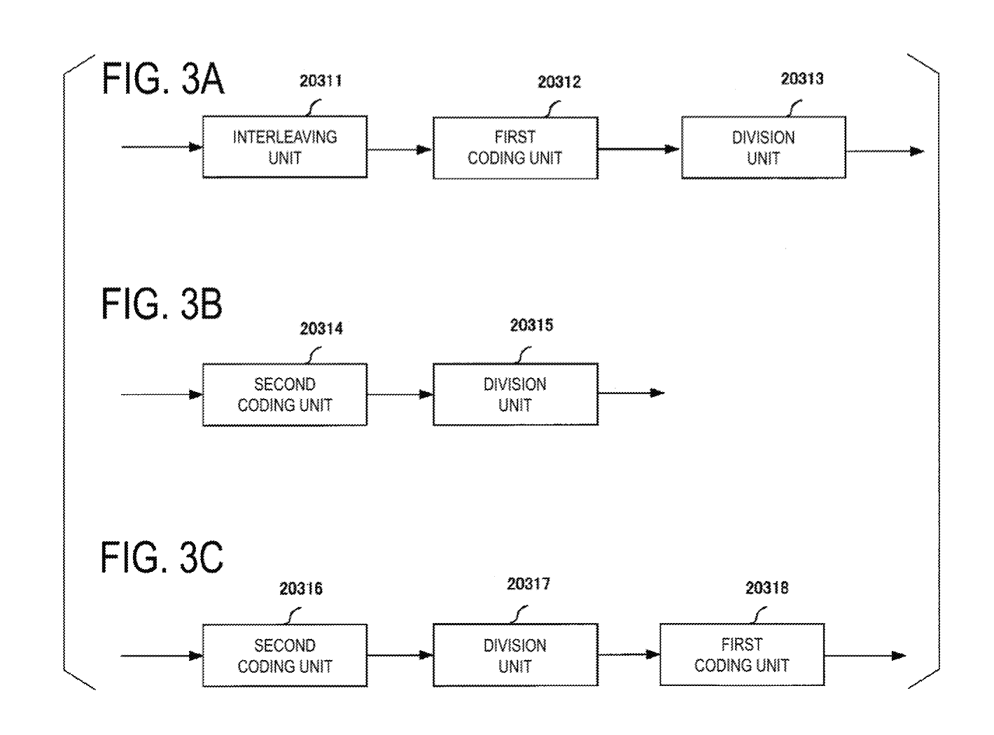

FIGS. 3A to 3C are block diagrams illustrating examples of a configuration of the coding unit 2031. FIGS. 3A to 3C illustrate three types of configurations.

FIG. 3A includes an interleaving unit (interleaving step) 20311, a first coding unit (first coding step) 20312, and a division unit (division step) 20313. The interleaving unit 20311 rearranges input bits (for example, transport blocks, information bits, or data bits). The first coding unit 20313 adds error correction coding and Cyclic Redundancy Check (CRC) bits to the information bits. The division unit 20313 divides the input bits into one or more blocks. Each of the blocks resulting from the division is also referred to as a coded block. The number of blocks resulting from the division by the division unit 20313 can be a fixed value (specified), a value indicated (configured) by the base station apparatus, or a random value. In this case, in a case that some of the one or more coded blocks have high communication quality, it is highly probable that the information bits can be correctly decoded by using error correction decoding.

FIG. 3B includes a second coding unit (second coding step) 20314 and a division unit (division step) 20315. The second coding unit 20314 performs rateless coding of input bits (for example, transport blocks, information bits, or data bits). The division unit 20315 divides the input bits into one or more blocks. CRC bits are added to the blocks resulting from the division, and the resultant blocks are output as coded blocks. The rateless coding is a type of erasure coding and allows coded bits to be decoded even in a case that some of the coded blocks are erased. In other words, in a case that some of the one or more coded blocks have high communication quality, it is highly probable that the information bits can be correctly decoded.

FIG. 3C includes a second coding unit (third coding step) 20316, a division unit (division step) 20317, and a first coding unit (first coding step) 20318. The second coding unit 20316 performs error correction coding or rateless coding of input bits (for example, transport blocks, information bits, or data bits). The division unit 20317 divides the input bits into one or more blocks. The first coding unit 20318 adds error correction coding and CRC bits to each of the blocks output by the division unit 20317 to generate coded blocks. Note that, in FIG. 3C, the second coding is also referred to as external coding, and the first coding is also referred to as internal coding. Accordingly, in a case that some of the one or more coded blocks can be correctly decoded, it is highly probable that the information bits can be correctly decoded by decoding external codes. Note that bit sequences resulting from division by the division unit 20317 may be referred to as transport blocks.

The terminal apparatus can transmit control information (decoding information) for the base station apparatus to perform decoding. The decoding information is added to coded blocks for transmission. The decoding information includes some or all of a data ID, a UEID, the number of coded blocks, and a coding ID. The data ID is an identifier for information bits (transport blocks). In a case that multiple coded blocks are transmitted for the same information bits, the same data ID is configured. In this case, the base station apparatus can collect coded blocks with the same data ID to decode the information bits. The UEID is an identifier for the terminal apparatus, and indicates which of the terminal apparatuses has performed transmission. Note that the UEID may be associated with some or all of the multiple access physical resource, the multiple access signature, the reference signal physical resource, and the reference signal signature. The number of coded blocks is the number of coded blocks in which information bits are transmitted, and is transmitted in a case that the terminal apparatus selects (determines) the number of coded blocks. The coding ID is an identifier for coding, and includes a coding scheme or a coding parameter. The coding scheme indicates which of the coding schemes has been used for coding. The coding parameter is a parameter used for coding, and includes a coding rate or an initial value (ID) for generating a pseudo-random sequence. The pseudo-random sequence is used to generate an interleaving pattern or a degree distribution of the LT codes/Raptor codes.

It is likely that a coded block (codeword) subjected to error correction coding can be correctly decoded in a case that the coded block has high communication quality, where no collision exists or no strong interference signal exists, for example. In FIGS. 3A to 3C described above, it is highly probable that the base station apparatus can correctly acquire information bits in a case that at least some of the multiple coded blocks transmitted by the terminal apparatus can be correctly decoded. Accordingly, it is important to reduce the probability of collision of coded blocks.

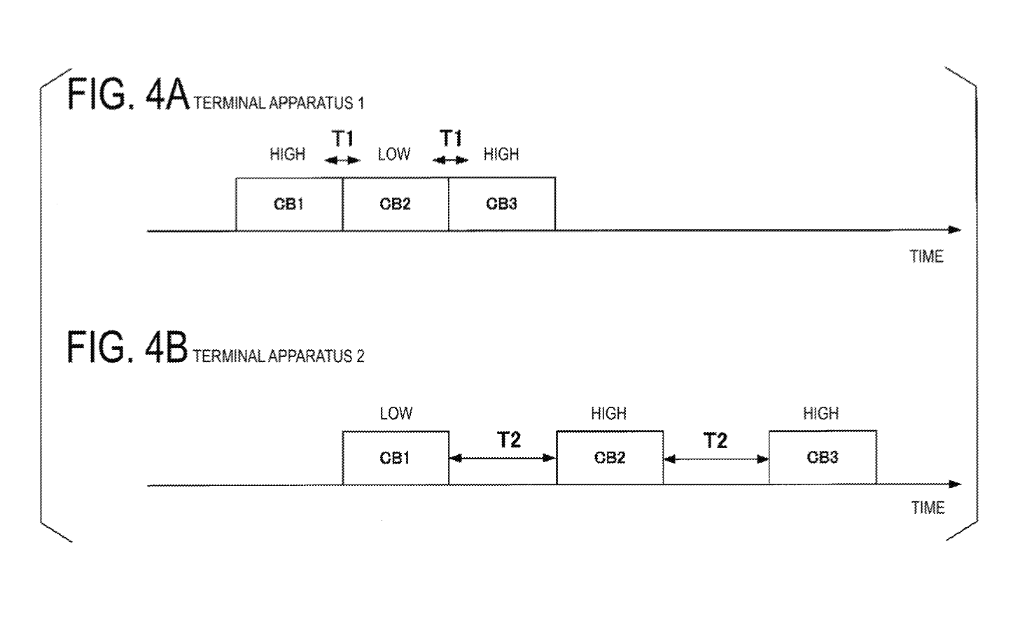

FIGS. 4A and 4B are diagrams illustrating examples of transmission timings (periods) for coded blocks. In FIGS. 4A and 4B, each of the terminal apparatus 1 (FIG. 4A) and the terminal apparatus 2 (FIG. 4B) performs transmission at a different transmission timing (period). In the examples in FIGS. 4A and 4B, each of the terminal apparatus 1 and the terminal apparatus 2 transmits three coded blocks (CB). The three coded blocks are represented as CB1, CB2, and CB3. Furthermore, T1 denotes a transmission period for a coded block in the terminal apparatus 1, and T2 denotes a transmission period for a coded block in the terminal apparatus 2. The transmission period is represented in T symbols/slots/subframes. Note that T is a positive integer and includes T=0. For T=0, each coded block is transmitted in continuous symbols/slots/subframes. Furthermore, the transmission period T is indicated or configured by the base station apparatus, or selected by the terminal apparatus. Note that the base station apparatus may indicate or configure a maximum value or candidates for T. In this case, the terminal apparatus can configure the transmission period to a value smaller than or equal to the maximum value of T or a value selected from the candidates of T. Furthermore, in FIGS. 4A and 4B, the communication quality of each coded block is represented as High or Low by way of example. For example, High represents good communication quality and corresponds to a coded block that can be correctly decoded. Low represents degraded communication quality due to a collision or the like and corresponds to a coded block that cannot be correctly decoded. In the examples in FIGS. 4A and 4B, CB2 of the terminal apparatus 1 collides with CB1 of the terminal apparatus, thus indicating Low. As described above, in a case that each of the terminal apparatuses performs transmission with a different transmission period, the probability of collision of coded blocks is reduced. This can improve the probability that the base station apparatus can correctly decode the information bits. Note that, although in FIGS. 4A and 4B the interval between CB1 and CB2 is the same as the interval between CB2 and CB3, the intervals may differ from each other. Furthermore, although in FIGS. 4A and 4B a time axis is used to describe the examples, a frequency axis can be similarly used. In this case, each terminal apparatus is required to perform transmission at a different subcarrier/subband spacing, and the probability of collision can be reduced even in a case that different transmissions are performed at the same transmission timing.

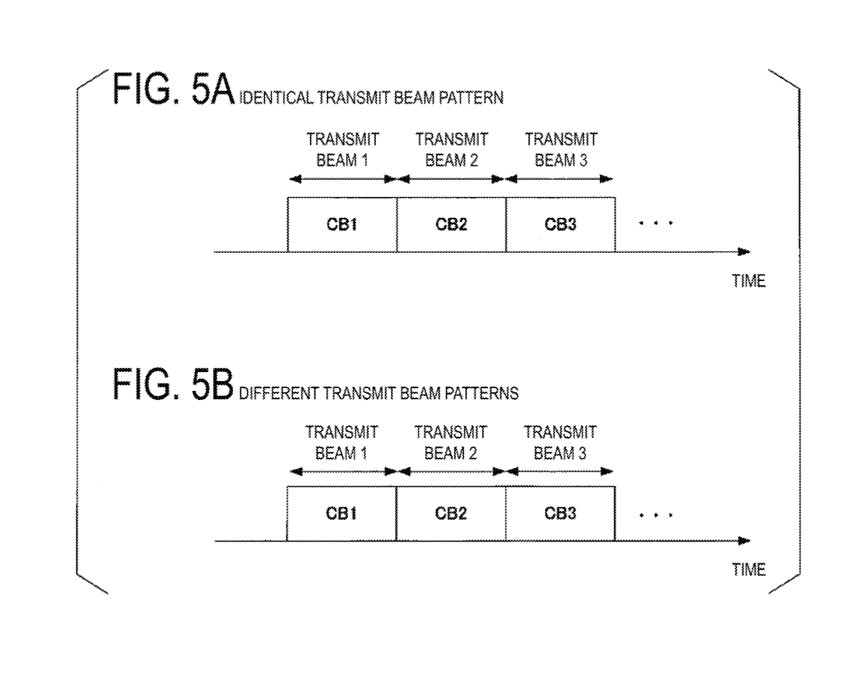

FIGS. 5A and 5B, FIG. 6 and FIGS. 7A and 7B are diagrams for illustrating examples in which beamforming is used. In particular, in a high frequency band, accurate beamforming is enabled by using a large number of (large scale) antennas. FIGS. 5A and 5B illustrate examples in which the terminal apparatus transmits multiple coded blocks. In FIG. 5A, the same transmit beam (beam pattern and beam direction) is used to transmit each coded block, and in FIG. 5B, a different transmit beam is used to transmit each coded block. In FIGS. 5A and 5B, the terminal apparatus transmits three coded blocks, CB1, CB2, and CB3. In a case that the same transmit beam is used for transmission, the terminal apparatus uses the same transmit beam 1 to transmit CB1, CB2, and CB3. In a case that different transmit beams are used for transmission, the terminal apparatus respectively uses the transmit beam 1, transmit beam 2, and transmit beam 3 to transmit CB1, CB2, and CB3. Note that in FIGS. 5A and 5B, the time axis is used to describe the examples. However, the frequency axis is similarly used to describe the examples. Furthermore, in each of multiple subarrays, a different transmit beam can be used to transmit each coded block. Note that the transmit beam is formed by analog beamforming, digital beamforming, hybrid analog and digital beamforming, or precoding. Furthermore, in a case that the same beamforming is used for a data signal and a demodulation reference signal, the base station apparatus can demodulate the data signal and the demodulation reference signal without any information about transmit beams.

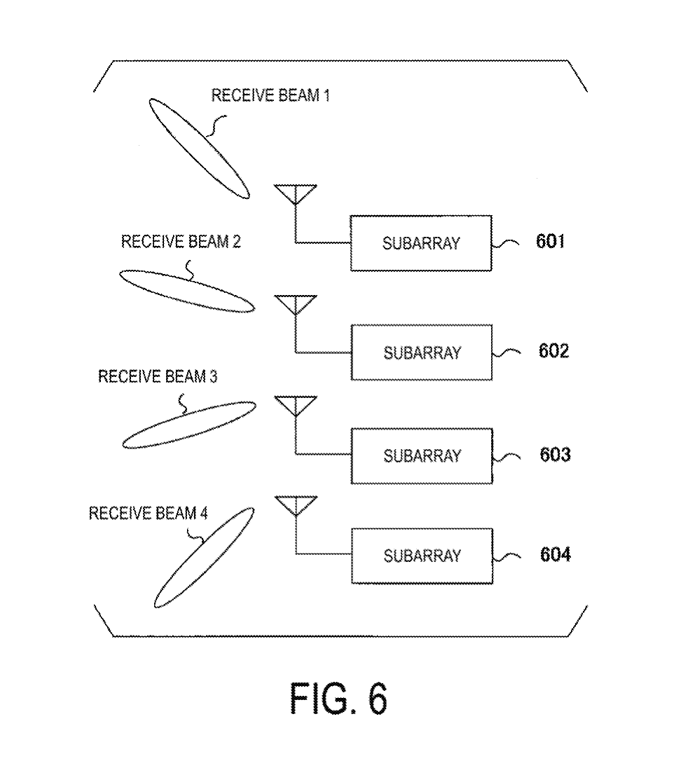

FIG. 6 is a diagram illustrating examples of receive beams (beam patterns and beam directions) of the base station apparatus. In FIG. 6, the base station apparatus includes a subarray 601, a subarray 602, a subarray 603, and a subarray 604. The subarrays can form different receive beams at the same reception timing. In the examples in FIG. 6, the subarray 601 forms a receive beam 1, the subarray 602 forms a receive beam 2, the subarray 603 forms a receive beam 3, and the subarray 604 forms a receive beam 4. The subarray includes some of antenna elements included in the base station apparatus. Each subarray may indicate an antenna port that is a logical antenna. Note that the number of subarrays may vary among the base station apparatuses. For example, the base station apparatus may include no subarray, in other words, all the antenna elements may form one receive beam. Furthermore, each subarray can temporally change the receive beam.

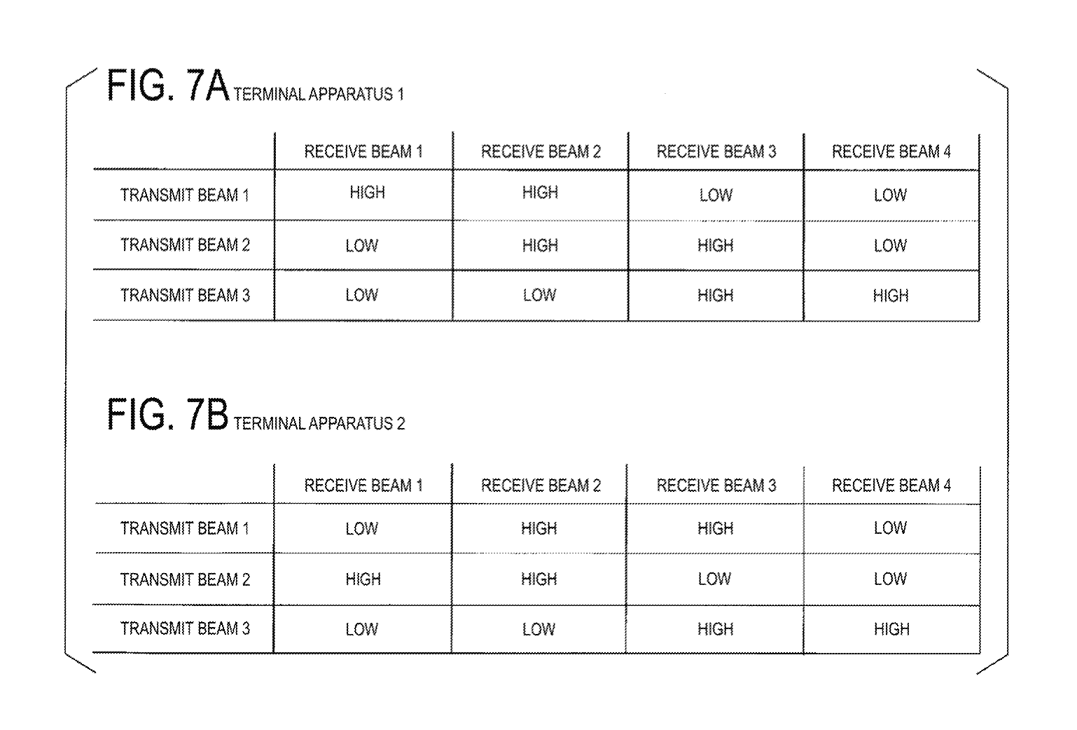

Communication quality of beamforming depends on a pair (combination) of the transmit beam and the receive beam. FIGS. 7A and 7B are diagrams illustrating examples of the communication quality of pairs of the transmit beam and the receive beam. FIG. 7A is an example of communication quality between the terminal apparatus 1 and the base station apparatus. FIG. 7B is an example of communication quality between the terminal apparatus 2 and the base station apparatus. Note that, in a case that the receive beam is fixed for each subarray, the communication quality of each receive beam can be referred to as the communication quality of the corresponding subarray. Furthermore, the communication quality of each pair of the transmit and receive beams is represented as High or Low as in the case of FIGS. 4A and 4B. In a case that the terminal apparatus 1 and the terminal apparatus 2 are located at different locations, the communication quality of each pair of the transmit and receive beams may vary as illustrated in FIGS. 7A and 7B. The terminal apparatus 1 and the terminal apparatus 2 are assumed to have transmitted a coded block at the same transmission timing as illustrated in FIG. 5B. The base station apparatus is assumed to have received the coded block at subarrays 601 to 604 via different receive beams 1 to 4, respectively. In this case, the communication quality of CB1 (transmit beam 1 in FIG. 7A) of the terminal apparatus 1 at each subarray (receive beam) is High for the receive beam 1 and the receive beam 2 and Low for the receive beam 3 and the receive beam 4. On the other hand, the communication quality of CB1 (transmit beam 1 in FIG. 7B) of the terminal apparatus 2 at each subarray (receive beam) is High for the receive beam 2 and the receive beam 3 and Low for the receive beam 1 and the receive beam 4. In a case of a subarray at which the communication quality of one of the terminal apparatus 1 and the terminal apparatus 2 is high, and the communication quality of the other one is low, only the coded block transmitted by the one of the terminal apparatuses is received, and it is highly probable that the coded block can be correctly decoded. In a case of a subarray (receive beam) at which both the communication quality of the terminal apparatus 1 and the communication quality of the terminal apparatus 2 are high, a collision of the coded block occurs, and it is less likely that the coded block can be correctly decoded. In a case of a subarray (receive beam) at which both the communication quality of the terminal apparatus 1 and the communication quality of the terminal apparatus 2 are low, a collision of the coded block occurs, and it is much less likely that the coded block can be correctly decoded. Accordingly, CB1 (transmit beam 1) of the terminal apparatus 1 can be correctly decoded by using the receive beam 1 (subarray 601), and CB1 (transmit beam 1) of the terminal apparatus 2 can be correctly decoded by using the receive beam 3 (subarray 603). Similarly, CB2 (transmit beam 2) of the terminal apparatus 1 can be correctly decoded by using the receive beam 3 (subarray 603), and CB2 (transmit beam 2) of the terminal apparatus 2 can be correctly decoded by using the receive beam 1 (subarray 601). Given a similar perspective, CB3s (transmit beams 3) of the terminal apparatus 1 and the terminal apparatus 2 have high communication quality for the receive beam 3 (subarray 603) and the receive beam 4 (subarray 604). However, a collision occurs, and it is highly probable that the CB3s cannot be correctly decoded. With the assumption that the terminal apparatus 1 and the terminal apparatus 2 have correctly decoded CB1 and CB2 and have not correctly decoded CB3, the base station apparatus can correctly decode the information bits from CB1 and CB2 in a case that the coding described in FIG. 3 is used that assumes a case where one CB may not be correctly decoded. Note that, as is the case with the examples in FIGS. 4A and 4B, the terminal apparatus 1 and the terminal apparatus 2 can transmit coded blocks with different transmission periods.

Note that the beamforming as described above can be used for a beam search for searching a preferable transmit beam and/or a preferable receive beam. For example, the terminal apparatus is assumed to cause data signals (coded block and PDSCH) to be time-multiplexed or frequency-multiplexed, the data signal resulting from beamforming with the transmit beam 1, transmit beam 2, and transmit beam 3, and transmit the data signals. The base station apparatus can recognize a transmit beam preferable for the terminal apparatus by using a certain receive beam to receive three data signals (coded blocks and PDSCHs) of different transmit beams and measuring the communication quality of the data signals. Furthermore, the terminal apparatus is assumed to transmit one or more data signals (coded blocks and PDSCHs) resulting from beamforming with the transmit beam 1, and the base station apparatus is assumed to receive the data signals by using different receive beams. In this case, the base station apparatus can recognize a receive beam with preferable communication quality. Furthermore, the base station apparatus decodes the received data signals (coded blocks and PDSCHs) to obtain information bits. Accordingly, a beam search can be performed during data communication, thus enabling efficient communication compared to a beam search by using a known signal such as a reference signal/synchronizing signal.

Note that multiple coded blocks can be transmitted from different transmission points. The number of transmission points from which the multiple coded blocks are transmitted can be limited to a prescribed value, The terminal apparatus may consider multiple coded blocks actually transmitted from different transmission points to have been transmitted from the same transmission point or from different transmission points, and demodulate the multiple coded blocks. The terminal apparatus may determine whether to consider the multiple coded blocks to have been transmitted from the same transmission point or from different transmission points, or the base station apparatus may notify (indicate, or configure), to the terminal apparatus, whether to consider the multiple coded blocks to have been transmitted from the same transmission point or from different transmission points. Note that, in a case of considering the multiple coded blocks to have been transmitted from different transmission points, the terminal apparatus can acquire information for indicating a transmission point from which a set of coded blocks with good demodulation results has been transmitted to notify (report) the information to the base station apparatus. Furthermore, the terminal apparatus can transmit the multiple coded blocks to different reception points. For example, the terminal apparatus can transmit the multiple coded blocks by using a different beam for each reception point.

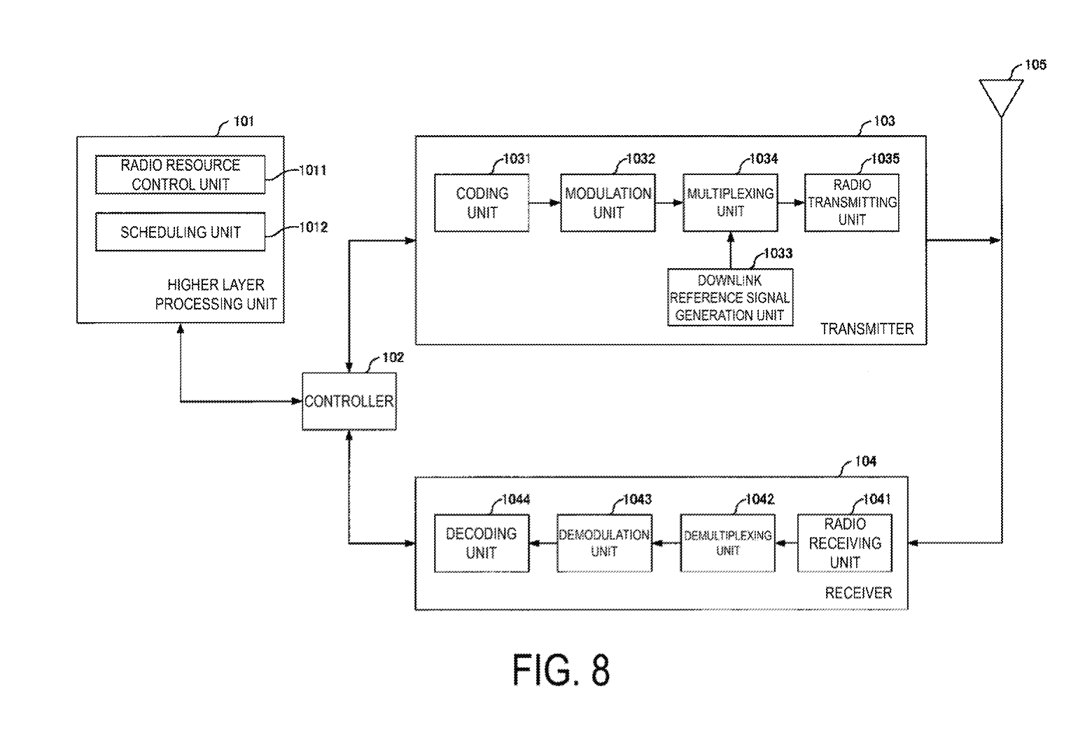

FIG. 8 is a schematic block diagram illustrating a configuration of the base station apparatus 1A according to the present embodiment. As illustrated in FIG. 8, the base station apparatus 1A is configured to include a higher layer processing unit (higher layer processing step) 101, a controller (controlling step) 102, a transmitter (transmitting step) 103, a receiver (receiving step) 104, and a transmit and/or receive antenna 105. The higher layer processing unit 101 is configured to include a radio resource control unit (radio resource controlling step) 1011 and a scheduling unit (scheduling step) 1012. The transmitter 103 is configured to include a coding unit (coding step) 1031, a modulation unit (modulating step) 1032, a downlink reference signal generation unit (downlink reference signal generating step) 1033, a multiplexing unit (multiplexing step) 1034, and a radio transmitting unit (radio transmitting step) 1035. The receiver 104 is configured to include a radio receiving unit (radio receiving step) 1041, a demultiplexing unit (demultiplexing step) 1042, a demodulation unit (demodulating step) 1043, and a decoding unit (decoding step) 1044.

The higher layer processing unit 101 performs processing of a Medium Access Control (MAC) layer, a Packet Data Convergence Protocol (PDCP) layer, a Radio Link Control (RLC) layer, and a Radio Resource Control (RRC) layer. Furthermore, the higher layer processing unit 101 generates information necessary for control of the transmitter 103 and the receiver 104, and outputs the generated information to the controller 102.

The higher layer processing unit 101 receives information of a terminal apparatus, such as a capability of the terminal apparatus (UE capability), from the terminal apparatus. To rephrase, the terminal apparatus transmits its function to the base station apparatus by higher layer signaling.

The radio resource control unit 1011 generates, or acquires from a higher node, the downlink data (the transport block) allocated in the downlink PDSCH, system information, the RRC message, the MAC Control Element (CE), and the like. The radio resource control unit 1011 outputs the downlink data to the transmitter 103, and outputs other information to the controller 102. Furthermore, the radio resource control unit 1011 manages various configuration information of the terminal apparatuses. Furthermore, the radio resource control unit 1011 configures (manages) the downlink reference parameter (subcarrier spacing), the CP length, the number of FFT points, and the like. Furthermore, the radio resource control unit 1011 configures (manages) the reference parameter (subcarrier spacing) for the terminal apparatus (uplink), the CP length, the number of FFT points, and the like.

The scheduling unit 1012 determines a frequency and a subframe to which the physical channels (PDSCH and PUSCH) are allocated, the coding rate and modulation scheme (or MCS) for the physical channels (PDSCH and PUSCH), the transmit power, and the like. The scheduling unit 1012 outputs the determined information to the controller 102.

The scheduling unit 1012 generates information to be used for scheduling the physical channels (PDSCH and PUSCH), based on the result of the scheduling. The scheduling unit 1012 outputs the generated information to the controller 102.

Based on the information input from the higher layer processing unit 101, the controller 102 generates a control signal for controlling the transmitter 103 and the receiver 104. The controller 102 generates the downlink control information based on the information input from the higher layer processing unit 101, and outputs the generated information to the transmitter 103.

The transmitter 103 generates the downlink reference signal in accordance with the control signal input from the controller 102, codes and modulates the HARQ indicator, the downlink control information, and the downlink data that are input from the higher layer processing unit 101, multiplexes PHICH, PDCCH, EPDCCH, PDSCH, and the downlink reference signal, and transmits a signal obtained through the multiplexing to the terminal apparatus 2 through the transmit and/or receive antenna 105.

The coding unit 1031 codes the HARQ indicator, the downlink control information, and the downlink data that are input from the higher layer processing unit 101, by using predetermined coding schemes of error correction coding and/or rateless coding and the like, or by using a coding scheme determined by the radio resource controller 1011. Examples of the error correction coding include block coding, convolutional coding, turbo coding, Low Density Parity Check (LDPC) coding, polar coding, Reed-Solomon coding, and Hamming coding. Examples of the rateless coding include Luby Transform (LT) coding and Raptor coding. The modulation unit 1032 modulates the coded bits input from the coding unit 1031, in compliance with a predetermined modulation scheme, such as Binary Phase Shift Keying (BPSK), Quadrature Phase Shift Keying (QPSK), quadrature amplitude modulation (16QAM), 64QAM, or 256QAM, or in compliance with the modulation scheme determined by the radio resource control unit 1011.

The downlink reference signal generation unit 1033 generates, as the downlink reference signal, a sequence, known to the terminal apparatus 2A, that is determined in accordance with a rule predetermined based on the physical cell identity (PCI, cell ID) for identifying the base station apparatus 1A, and the like.

The multiplexing unit 1034 multiplexes the modulated modulation symbol of each channel, the generated downlink reference signal, and the downlink control information. To be more specific, the multiplexing unit 1034 maps the modulated modulation symbol of each channel, the generated downlink reference signal, and the downlink control information to the resource elements.

The radio transmitting unit 1035 performs Inverse Fast Fourier Transform (IFFT) of a modulation symbol resulting from multiplexing or the like to generate an OFDM symbol, attaches a Cyclic Prefix (CP) to the generated OFDM symbol to generate a baseband digital signal (OFDM signal), converts the baseband digital signal into an analog signal, removes unnecessary frequency components from the analog signal through filtering, up-converts the resultant analog signal into a signal of a carrier frequency, performs power amplification to generate a radio signal, and outputs the radio signal to the transmit and/or receive antenna 105 for transmission.

In accordance with the control signal input from the controller 102, the receiver 104 demultiplexes, demodulates, and decodes the reception signal received from the terminal apparatus 2A through the transmit and/or receive antenna 105, and outputs information resulting from the decoding to the higher layer processing unit 101.

The radio receiving unit 1041 converts, by down-converting, an uplink signal received through the transmit and/or receive antenna 105 into a baseband signal, removes unnecessary frequency components, controls the amplification level in such a manner as to suitably maintain a signal level, performs orthogonal demodulation based on an in-phase component and an orthogonal component of the received signal, and converts the resulting orthogonally-demodulated analog signal into a digital signal.

The radio receiving unit 1041 removes a portion corresponding to CP from the digital signal resulting from the conversion. The radio receiving unit 1041 performs Fast Fourier Transform (FFT) of the signal from which the CP has been removed, extracts a signal in the frequency domain, and outputs the resulting signal to the demultiplexing unit 1042.

The demultiplexing unit 1042 demultiplexes the signal input from the radio receiving unit 1041 into signals such as PUCCH, PUSCH, and uplink reference signal. The demultiplexing is performed based on radio resource allocation information, included in the uplink grant notified to each of the terminal apparatuses 2, that is predetermined by the base station apparatus 1A by using the radio resource control unit 1011.

Furthermore, the demultiplexing unit 1042 performs channel compensation for PUCCH and PUSCH. The demultiplexing unit 1042 demultiplexes the uplink reference signal.

The demodulation unit 1043 performs Inverse Discrete Fourier Transform (IDFT) of PUSCH, acquires modulation symbols, and demodulates, for each of the modulation symbols of PUCCH and PUSCH, a reception signal in compliance with a predetermined modulation scheme, such as BPSK, QPSK, 16QAM, 64QAM, and 256QAM, or in compliance with a modulation scheme that the base station apparatus 1A notified to each of the terminal apparatuses 2 in advance by using the uplink grant.

The decoding unit 1044 decodes the coded bits of PUCCH and PUSCH that have been demodulated, at a coding rate, in compliance with a predetermined coding scheme, that is predetermined or notified from the base station apparatus 1A to the terminal apparatus 2 in advance by using the uplink grant, and outputs the decoded uplink data and uplink control information to the higher layer processing unit 101. In a case where PUSCH is retransmitted, the decoding unit 1044 performs the decoding by using the coded bits that is input from the higher layer processing unit 101 and retained in an HARQ buffer, and the demodulated coded bits.

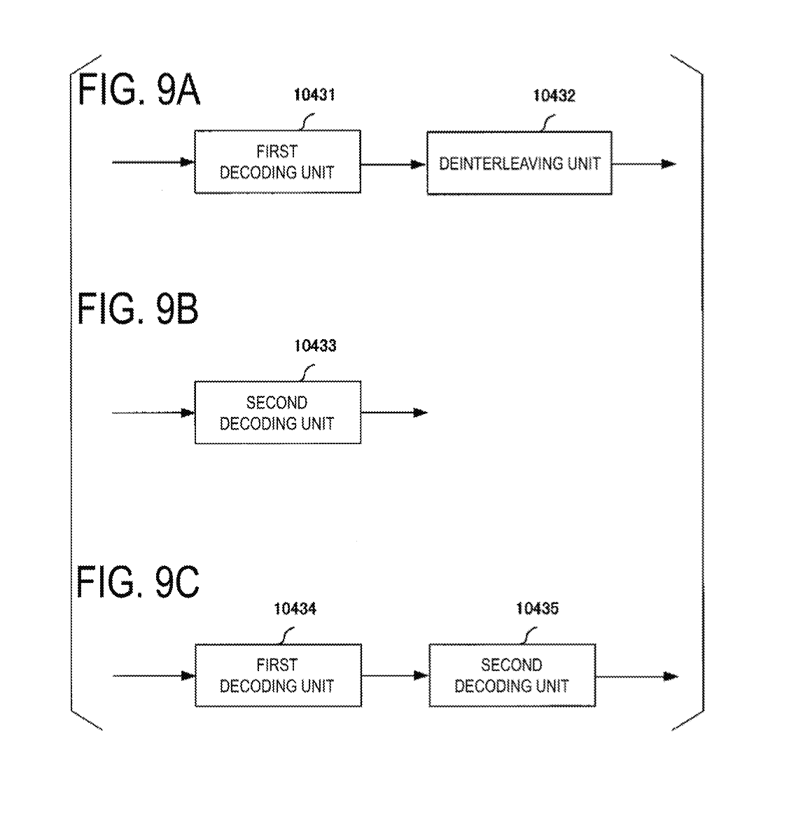

FIGS. 9A to 9C illustrate examples of a configuration of the decoding unit 1044 corresponding to the coding unit 2031 described in FIGS. 3A to 3C. FIG. 9A corresponds to FIG. 3A, FIG. 9B corresponds to FIG. 3B, and FIG. 9C corresponds to FIG. 3C.

FIG. 9A includes a first decoding unit (first decoding step) 10431 and a deinterleaving unit (deinterleaving step) 10432. The first decoding unit 10431 performs error correction decoding on one or more coded blocks, received from the terminal apparatus, that have the same data ID. The deinterleaving unit 10432 performs reverse rearrangement processing to the rearrangement processing of the interleaving unit 20311 on an output from the first decoding unit 10431 to obtain information bits.

FIG. 9B includes a second decoding unit 10433. One or more coded blocks, received from the terminal apparatus, that have the same data ID are decoded to obtain information bits.

FIG. 9C includes a first decoding unit 10434 and a second decoding unit 10435. The first decoding unit 10434 performs error correction decoding on coded blocks received from the terminal apparatus. The second decoding unit 10435 decodes one or more coded blocks that can be decoded without any error by the first decoding unit 10434 and that have been transmitted from the same terminal apparatus and that have the same data ID, to obtain information bits.

The base station apparatus transmits HARQ-ACK for an uplink signal to the terminal apparatus. In a case that the terminal apparatus has transmitted the multiple coded blocks described in FIGS. 3A to 3C, NACK is transmitted to the terminal apparatus in a case that the information bits cannot be correctly decoded. A case where the information bits cannot be correctly decoded may correspond to two cases: a case where none of the coded blocks have been correctly received; and a case where some or all of the coded blocks have been correctly received but the information bits have not been correctly decoded. Here, NACK1 designates the case where none of the coded blocks have been correctly received, and NACK2 designates the case where some or all of the coded blocks have been correctly received but the information bits have not been correctly decoded. The base station apparatus can transmit HARQ-ACK that includes NACK1 and NACK2. In a case of NACK1, none of the coded blocks have been correctly received, thus the terminal apparatus desirably transmits coded blocks the number of which is equal to or larger than the number of coded blocks initially transmitted. Unlike NACK1, NACK2 means that some coded blocks have been correctly received, thus the number of coded blocks to be retransmitted in NACK 2 can be smaller than the number of coded blocks initially transmitted. The base station apparatus can indicate or configure, to the terminal apparatus, the number of coded blocks for the initial transmission and the number of coded blocks for the retransmission. In this case, as for the initial transmission and the retransmission based on NACK1, the terminal apparatus transmits coded blocks the number of which is indicated or configured as the number of coded blocks for the initial transmission. Furthermore, as for the retransmission based on NACK2, the terminal apparatus transmits coded blocks, the number of which is indicated or configured as the number of coded blocks for retransmission. Note that the base station apparatus can dynamically indicate the number of coded blocks for retransmission in accordance with the number of coded blocks correctly received. For example, the number of coded blocks for retransmission can be piggybacked with HARQ-ACK for transmission.

Furthermore, as for NACK1, in a case that none of the coded blocks have been correctly received due to collision, the retransmissions by the terminal apparatuses at the same timing (transmit beam) cause all the coded blocks to collide with one another again. Thus, for retransmission, the terminal apparatus can select a transmission period and/or a transmit beam that is the same as or different from the transmission period and/or the transmit beam for the initial transmission for transmission.

Furthermore, in a case that the base station apparatus and the terminal apparatus communicate with each other by using an unlicensed band, the base station apparatus and the terminal apparatus need to perform, before communication, carrier sense to determine whether a communication medium (radio resource) is being used by another terminal apparatus. The following method is an example of the carrier sense. In a case that received power of a signal received by the terminal apparatus exceeds a prescribed threshold (carrier sense level or Channel Clear Assessment (CCA) level), it is determined that the communication medium is in use (busy state). In a case that the received power is lower than or equal to the prescribed threshold, it is determined that the communication medium is not in use (idle state). In this case, in a case that the terminal apparatus increases the prescribed threshold, the probability of determining that the communication medium is in the idle state is increased, thus allowing an acquisition rate for communication opportunities to be improved. However, this also increases the probability of the collision of a packet transmitted by the terminal apparatus with a packet transmitted by another terminal apparatus. Thus, the terminal apparatus can configure a carrier sense level to a value larger than the value of a prescribed carrier sense level based on the coding scheme used for the received packet. For example, in a case that it is determined that the received packet is part of multiple coded blocks, it is highly probable that the received packet can be correctly decoded by the remaining coded blocks even in a case that the communication quality of the received packet is degraded. Thus, the terminal apparatus can configure the carrier sense level to a value larger than the value of a prescribed carrier sense level to perform the carrier sense. Alternatively, the terminal apparatus can change the carrier sense level in accordance with, for example, the type of code or the coding rate used for the received packet. Note that the base station apparatus can of course similarly perform the above-described dynamic change of the carrier sense level.

Note that the unlicensed band is a frequency band for which no license to use is required from a national or local government, but that the base station apparatus and terminal apparatus according to the present embodiment can perform, even in another frequency band, communication in which the carrier sense is performed as described above. The frequency bands covered by the present embodiment include a frequency band called a white band that is not actually used because of different purposes including preventing interference between different frequencies even though a license to use the frequency band for a specific service has been granted by the national or local government (for example, a frequency band that is allocated for television broadcasting but that is not being used in some regions), and a shared frequency band that has been exclusively allocated to a specific operator, and that is expected to be shared among multiple operators in the future. Note that the base station apparatus and the terminal apparatus can of course also perform communication based on the carrier sense in what is called a licensed band for which a license to use has been granted by the government of the country or region where the operator provides services.

The base station apparatus can notify the terminal apparatus of control information for indicating whether to allow the dynamic change of the carrier sense level based on the coding scheme used for the packet as described above. In a case that the control information allows no dynamic change of the carrier sense level, the terminal apparatus is not allowed to perform the dynamical change of the carrier sense level even in a case that it is determined that the received packet is part of multiple coded blocks. The base station apparatus and the terminal apparatus can include, in a packet to be transmitted, information for indicating the coding scheme (including the coding rate and the number of coded blocks) used for the packet. The information can be included as header information of the physical layer and the MAC layer. Note that the base station apparatus and the terminal apparatus change the carrier sense level based on the information, and it is desirable that the information can be acquired as easily as possible. The base station apparatus and the terminal apparatus can perform signaling, to a reception apparatus, the coding scheme used for a packet to be transmitted, based on a waveform and a modulation scheme used for the packet (for example, based on the coding scheme, π/2 shift BPSK is used in a case a prescribed coding scheme is used, and BPSK is used in a case that a coding scheme other than the prescribed coding scheme is used) or a signal transmission method (for example, a prescribed signal is repeatedly transmitted a prescribed number of times).

The above-described dynamic change of the carrier sense may be performed within an occupancy period reserved (acquired) by the base station apparatus through the carrier sense. Note that the occupancy period reserved (acquired) by the communication apparatus (the base station apparatus, the terminal apparatus, or the like) through the carrier sense is also referred to as Maximum Channel Occupancy Time (MCOT). In this case, the base station apparatus can transmit information about MCOT to the terminal apparatus.

A program running on an apparatus according to an aspect of the present invention may serve as a program that controls a Central Processing Unit (CPU) and the like to cause a computer to operate in such a manner as to realize the functions of the above-described embodiment according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing functions of an embodiment related to an aspect of the present invention may be recorded in a computer-readable recording medium. The functions may be realized by causing a computer system to read the program recorded in the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining a program for a short time, or any other computer-readable recording medium.

Furthermore, each functional block or various characteristics of the apparatuses used in the above-described embodiment may be implemented or performed in an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit or an analog circuit. Furthermore, in a case that with advances in semiconductor technology, a circuit integration technology appears that replaces the present integrated circuits, one or more aspects of the present invention can use a new integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications can be made to the aspect of the present invention within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be suitably used in a base station apparatus, a terminal apparatus, and a communication method. An aspect of the present invention can be utilized, for example, in a communication system, communication equipment (for example, a cellular phone apparatus, a base station apparatus, a radio LAN apparatus, or a sensor device), an integrated circuit (for example, a communication chip), or a program.

### REFERENCE SIGNS LIST

1A Base station apparatus
2A, 2B Terminal apparatus
101 Higher layer processing unit
102 Controller
103 Transmitter
104 Receiver
105 Transmit and/or receive antenna
1011 Radio resource control unit
1012 Scheduling unit
1031 Coding unit
1032 Modulation unit
1033 Downlink reference signal generation unit
1034 Multiplexing unit
1035 Radio transmitting unit
1041 Radio receiving unit
1042 Demultiplexing unit
1043 Demodulation unit
1044 Decoding unit
10431, 10434 First decoding unit
10432 De-interleaving unit
10433, 10435 Second decoding unit
201 Higher layer processing unit
202 Controller
203 Transmitter
204 Receiver
205 Channel state information generation unit
206 Transmit and/or receive antenna
2011 Radio resource control unit
2012 Scheduling information interpretation unit
2031 Coding unit
2032 Modulation unit
2033 Uplink reference signal generation unit
2034 Multiplexing unit
2035 Radio transmitting unit
2041 Radio receiving unit
2042 Demultiplexing unit
2043 Signal detection unit
20311 Interleaving unit
20312, 20318 First coding unit
20313, 20315, 20317 Division unit
20314, 20316 Second coding unit
601, 602, 603, 604 Subarray

1. A terminal apparatus for communicating with a base station apparatus, the terminal apparatus comprising:
a coding unit; and
a radio transmitting unit, wherein
the coding unit includes a first coding unit, a division unit, and a second coding unit,
the first coding unit codes information bits by using first coding,
the division unit divides an output from the first coding unit into blocks,
the second coding unit performs error correction coding on each of the blocks output by the division unit to generate a coded block, and
the radio transmitting unit transmits a plurality of the coded blocks at a random transmission timing.

2. The terminal apparatus according to claim 1, wherein
the coded block includes a data ID for identifying the information bits.

3. The terminal apparatus according to claim 1, wherein
the number of blocks resulting from division by the division unit is indicated by the base station apparatus.

4. The terminal apparatus according to claim 1, wherein
an ACK/NACK signal for the information bits is received from the base station apparatus, and
the radio transmitting unit transmits coded blocks, the number of which is different from the number of the coded blocks initially transmitted, in a case that the ACK/NACK signal indicates NACK.

5. The terminal apparatus according to claim 1, wherein
an ACK/NACK signal for the information bits is received from the base station apparatus, and
the radio transmitting unit transmits coded blocks at a transmission interval different from the transmission interval for initial transmission in a case that the ACK/NACK signal indicates NACK.

6. The terminal apparatus according to claim 1, wherein the radio transmitting unit performs beamforming of a plurality of the coded blocks by using different transmit beams, and transmit the plurality of the coded blocks resulting from the beamforming.

7. A base station apparatus for communicating with a terminal apparatus, the base station apparatus comprising:
a radio receiving unit configured to receive at least one coded block transmitted from the terminal apparatus at a random timing; and
a decoding unit configured to decode the at least one coded block, wherein
the decoding unit includes a first decoding unit configured to perform error correction decoding on each of the at least one coded block, and a second decoding unit configured to decode an output from the first decoding unit to detect information bits.

8. The base station apparatus according to claim 7, wherein
each of the at least one coded block includes a data ID for identifying the information bits, and
the decoding unit detects the information bits from the at least one coded block with an identical data ID.

9. The base station apparatus according to claim 7, wherein
the number of the at least one coded block is indicated to the terminal apparatus.

10. The base station apparatus according to claim 7, wherein the radio receiving unit receives the at least one coded block on which beamforming is performed by using different transmit beams.

11. A communication method in a terminal apparatus for communicating with a base station apparatus, the communication method comprising the steps of:
coding; and
performing radio transmission, wherein
the step of coding includes first coding, dividing, and second coding,
the step of first coding codes information bits by using first coding,
the step of dividing divides an output from the step of first coding into blocks,
the step of second coding performs error correction coding on each of the blocks output from the step of dividing to generate a coded block, and
the step of performing radio transmission transmits a plurality of the coded blocks at a random transmission timing.

12. A communication method in a base station apparatus for communicating with a terminal apparatus, the communication method comprising the steps of:
receiving at least one coded block transmitted from the terminal apparatus at a random timing; and
decoding the at least one coded block, wherein
the step of decoding includes first decoding for performing error correction decoding on each of the at least one coded block and second decoding for decoding an output from the first decoding to detect information bits.
